(19) United States
(12) Patent Application Publication
(10) Pub. No.: US 2008/0250346 A1
(43) Pub. Date: Oct. 9, 2008

(54) DATA STORAGE AND DISPLAY DEVICE

(76) Inventor: Paul Kaufmann, Carmel, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/049,453

(22) Filed: Mar. 17, 2008

Related U.S. Application Data
(60) Provisional application No. 60/910,511, filed on Apr. 6, 2007.

(51) Int. Cl. G06F 3/048

(52) U.S. Cl. 715/806; 715/781

(57) ABSTRACT

A process for providing information related to an individual or an animal in a portable display and storage device that allows other individuals to access the personal and medical information quickly. The process includes entering the information in formatted screens of data in a computer, transferring the formatted screens of data to the portable display and storage device, storing the formatted screens of data in the portable display and storage device, and displaying the formatted screens of data in the portable display and storage device. In some embodiments, the formatted screens of data in the display and storage device are transferred to a computer, modified, and transferred back to the display and storage device.

### CROSS REFERENCE TO RELATED APPLICATIONS

This application claims the benefit of U.S. patent application Ser. No. 60/910,511 filed Apr. 6, 2007, which is hereby incorporated by reference in its entirety.

### BACKGROUND

There are many ways to store an individual's medical and personal information on a portable device that an individual can carry on himself. For example, one type of portable device provides for digital storage and retrieval of a user's medical records. With this portable device, medical records can be retrieved from the portable device and displayed on a computer or laptop. This type of portable device is not very convenient in an emergency situation where medical personal need quick access to medical records in order to save a person's life.

Another example of a portable device is small enough to fit on a person's wrist and includes a wristband for attachment to the person's wrist. This portable wristband device includes a memory for storing acquired data, a keyboard for inputting data to the memory, and a screen for displaying data. Often users of portable wristband devices have medical conditions and may be elderly in age. Furthermore, these persons may have limited hand dexterity and may find it difficult to input information on the small keyboard found on the portable wristband device. Moreover, the retrieval of necessary medical information from the portable wristband device may be difficult since each user of the device may input the information in a different way leading to variability in the display of the information among various wristband devices. The variability in the display of medical information may lead to a delay in time for medical personal to retrieve necessary information quickly, especially in an emergency situation.

The present invention addresses these and other needs.

### SUMMARY

In one embodiment, a process for providing information related to an individual in a data display and storage device includes entering information of the individual into a plurality of electronic formatted screens on a computer, transferring the electronic formatted screens to the data display and storage device, storing the electronic formatted screens in the data display and storage device, and displaying in a sequential order only those electronic formatted screens that contain the information of the individual. In this way, medical personal or others can quickly retrieve vital medical and personal information of an individual in an emergency situation from to the data display and storage device. Moreover, the medical and personal information has been formatted into unique screens of data such that medical personal or others are able to find the relevant information easily. In another embodiment, the medical and personal information in the electronic formatted screens of data is transferred to a computer such that the medical and personal information is revised, edited, and transferred to the data display and storage device as needed. By transferring the electronic formatted screens of data to a computer, the individual can more easily modify the medical and personal information. In some embodiments, the process includes providing information for more than one individual in the data display and storage device.

### DESCRIPTION OF THE DRAWINGS

FIG. 1 is a front view of a data storage and display device of one embodiment.

FIG. 2 is a back view of the data storage and display device of FIG. 1.

FIG. 3 is a perspective view of the data storage and display device of FIG. 1.

FIG. 4 is a simulated screen of one embodiment of the data storage and display device of FIG. 1 showing the input information according to one embodiment.

FIG. 5 is a simulated screen of one embodiment of the data storage and display device of FIG. 1 showing health care information of an individual according to one embodiment.

FIG. 6 is a simulated screen of one embodiment of the data storage and display device of FIG. 1 showing allergy information of an individual according to one embodiment.

FIG. 7 is a simulated screen of one embodiment of the data storage and display device of FIG. 1 showing medical condition information of an individual according to one embodiment.

FIG. 8 is a simulated screen of one embodiment of the data storage and display device of FIG. 1 showing medical condition information of an individual according to another embodiment.

FIG. 9 is a simulated screen of one embodiment of the data storage and display device of FIG. 1 showing information for the health care professionals that provide care for an individual according to one embodiment.

FIG. 10 is a simulated screen of one embodiment of the data storage and display device of FIG. 1 showing information for the health care professionals according to another embodiment.

FIG. 11 is a simulated screen of one embodiment of the data storage and display device of FIG. 1 showing the current medication and dosages for an individual according to one embodiment.

FIG. 12 is a diagrammatic view of a process of one embodiment of the present invention for use with the data storage and display device of FIGS. 1-11.

FIG. 13 illustrates a high-level process flow diagram for the data storage and display device of FIGS. 1-11 and the system of FIG. 12.

FIG. 14 illustrates the data storage and display device of FIG. 1 connected with a personal computer.

FIG. 15 is a formatted page of data from the personal computer of FIG. 14.

FIG. 16 is a front view of a data storage and display device of another embodiment.

FIG. 17 is a front view of a data storage and display device of yet another embodiment.

FIG. 18 is a front view of a data storage and display device of another embodiment.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the inventions as illustrated therein being contemplated as would normally occur to one skilled in the art to which the invention relates.

One embodiment concerns a unique process for formatting an individual's personal and medical information into a plurality of electronic standardized screens, transferring the electronic standardized screens into a data storage and display device, storing the electronic standardized screens in the data storage and display device, and electronically displaying screens that have user information on the data storage and display device. Such personal information may include but is not limited to a person's name, address, telephone number, birth date, health care surrogate, allergies, medical conditions, health care providers, current medications and dosages, and any other pertinent medical information deemed essential to providing care to the person. In this system, the user can enter his or her personal information as often as desired on a computer in formatted fields and transfer the formatted information to their personal data storage and display device. The data storage and display device can store more than one individual's information. The electronic nature of the data storage and display device allows the user to save and display information on it. The data storage and display device is small such that the user can carry the data storage and display device with them thereby ensuring medical personnel, emergency personnel, and/or the user have immediate access to the user's medical and personal information. Moreover, the personal information has been formatted into standardized screens that are displayed on the data storage and display device by simply pressing a button and scrolling through the screens. The simplicity of the data storage and display device allows any person to click on the buttons and view the information formatted in easy to read screens on the device without additional equipment. In some embodiments, only those screens that contain data are displayed. In one form, the data storage and display device transmits the electronic standardized screens to receiving facilities such as a 911 facility, a hospital emergency room, or a doctor's office. In another form, the data storage and display device includes a global positioning system (“GPS”) receptor. The current location of the patient as determined by the GPS is continuously stored in the internal memory of the data storage and display device and is therefore available for transmission to emergency personnel so that the user can be located and treated. This is very beneficial for those individuals who live alone.

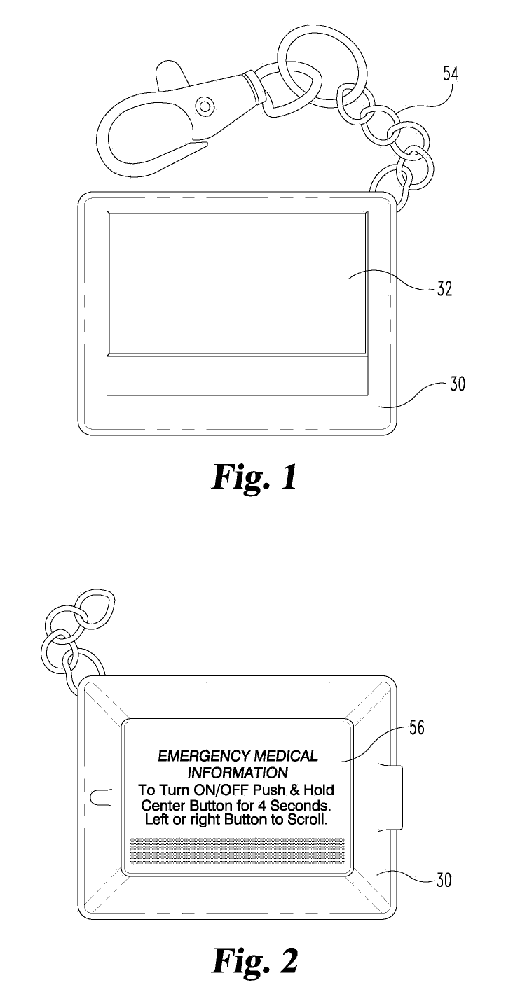

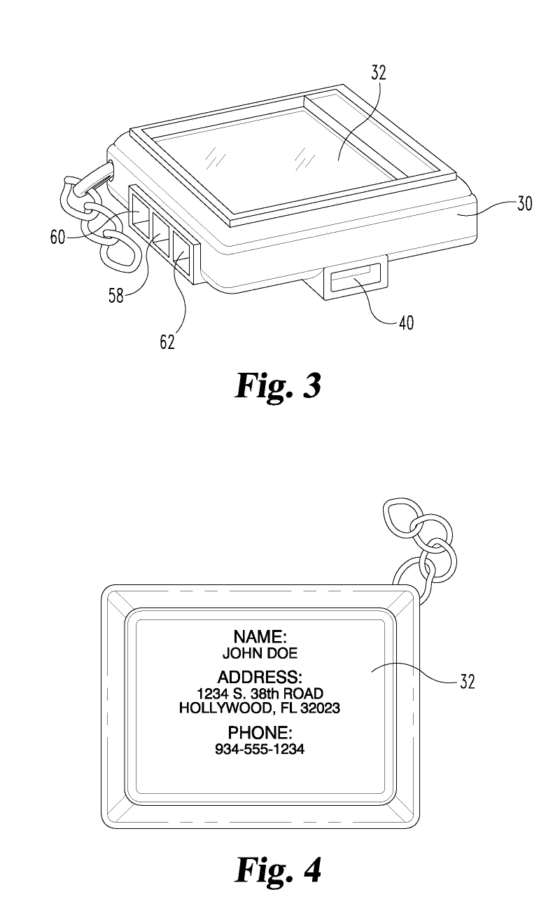

FIG. 1 is a front view of a data storage and display device 30 of one embodiment. Other types of data storage and display devices can be used with the process of providing information related to an individual. Some examples of data storage and display devices include a cellular telephone, a personal digital assistant or PDA, a palmtop, and a hand held electronic organizer, to name a few. The data storage and display device 30 is portable such that an individual can carry the device on his person. For example, the data storage and display device 30 can fit in a pocket of a shirt or pants so that an individual can carry the device on himself, the data storage and display device 30 can be attached to a necklace and worn on an individual's neck, or the data storage and display device 30 can be carried in an individual's hand. Data storage and display device 30 includes a screen 32, an internal memory 34 (not illustrated in FIG. 1), a photo library 36 (not illustrated in FIG. 1), a battery 38 (not illustrated in FIG. 1), a personal computer (PC) interface 40 (illustrated in FIG. 3), and a software package 42 (not illustrated in FIG. 1). In some embodiments, the data storage and display device 30 may include an AC adapter 44 (not illustrated in FIG. 1), a USB cable 46 (not illustrated in FIG. 1), a CD-ROM 48 (not illustrated in FIG. 1), a user's manual 50 (not illustrated in FIG. 1), a necklace 52 (not illustrated in FIG. 1), and a keychain 54.

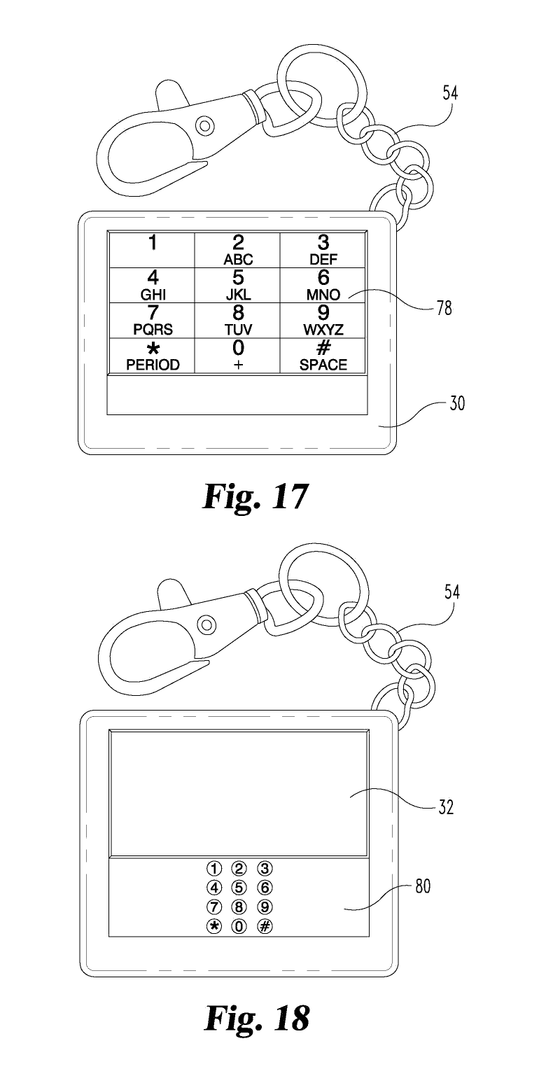

In the illustrated embodiment, the data storage and display device 30 is rectangular in shape; however, in other embodiments the data storage and display device 30 may be shaped differently such as round, polygonal, or triangular, to name a few. In one embodiment, the approximate size of the data storage and display device 30 is two inches width, two inches length, and 0.5 inches depth. In this embodiment, the data storage and display device 30 weighs 1.2 ounces or less. In the illustrated embodiment, the approximate size of the screen 32 is 1.4 inches width and 1.4 inches length. In another embodiment, the data storage and display device 30 has a width of 9 inches and a length of 12 inches. In this embodiment, the screen 32 has a width of 8.5 inches and a length of 11 inches. In yet another embodiment, the data storage and display device 30 has a width of 6 inches and a length of 8 inches. In this embodiment, the screen 32 has a width of 5 inches and a length of 7 inches. In another embodiment, the data storage and display device 30 has a width of 1.5 inches, a length of 2 inches, and a depth of 0.375 inches. In yet another embodiment, the data storage and display device is the approximate size of a credit card. The data storage and display device 30 and screen 32 can each be configured differently in other embodiments. For example, screen 32 can be a touch screen keypad 78 as shown in FIG. 17 and described below. As another example, display device 30 includes a keypad 80 as shown in FIG. 18 and described below.

In one embodiment, the internal memory 34 is approximately 8 megabytes. In another embodiment, the internal memory 34 is approximately 5 gigabytes. The internal memory 34 can be configured differently in other embodiments. In another embodiment, the photo library 36 includes fifty-six digital images. The photo library 36 can be configured differently in other embodiments to include any specified number of digital images. The battery 38 in one embodiment is a nickel cathode-cadmium anode (NICAD) re-chargeable battery. In this embodiment, the battery 38 has approximately 2.5 hours of continuous use life and approximately 100 hours of shelf life for non-use. In another embodiment, the battery 38 has approximately 3 hours of continuous use life and approximately 1 week of shelf life for non-use. The battery 38 can be configured differently in other embodiments. The PC interface 40 is a USB Port 1.1 but can be configured differently in other embodiments. For example, the interface 40 can be a wireless interface. The software package 42 can include various types of software such as an image transfer 4.0 system or another proprietary software system. One example of a proprietary software system is sold by JanTel Sales, Inc. Either of these software systems can be used for data transfer from a computer. The software package 42 can be configured differently in other embodiments.

As illustrated in FIG. 2, the back of the data storage and display device 30 includes instructions 56. The instructions 56 include basic information and directions to retrieve information from the data storage and display device 30. In other embodiments, the back of the data storage and display device 30 includes other information or is empty.

As illustrated in FIGS. 3 and 16, the data storage and display device 30 includes an On/Off button 58, a scroll up button 60, and a scroll down button 62. As should be appreciated, the data storage and display device 30 can include other mechanisms to turn the data storage and display device 30 on and off and to direct the data storage and display device 30 to display different screens of information. In one embodiment, the data storage and display device 30 includes a USB port such that medical facilities, doctor's offices, and/or hospitals can download the photo library 36.

In one form, to operate the data storage and display device 30, a user simply depresses the On/Off button 58 to turn on the device 30. In one embodiment, an initial sign-on page appears displaying the first page or electronic screen of data on the screen 32. To display the subsequent page or screen of data on the screen 32, the user depresses the scroll up button 60. To return to the previous page or screen of data on the screen 32, the user depresses the scroll down button 62. In one form, to erase information or a screen of data from the internal memory 34, the scroll up button 60 is depressed and held down for about four seconds. The data storage and display device 30 can include other forms or mechanisms to turn the device on and off, to maneuver between the screens of information, to erase or edit the screens of data, and/or to adjust the font size and/or the color of the screens or text, to name a few details that may be adjustable.

In one process, up to fifty-six digital pages or screens in the photo library 36 are stored in the internal memory 34 of the data storage and display device 30. Some of the pages from the photo library 36 are displayed on the screens 32 as illustrated in FIGS. 4, 5, 6, 7, 8, 9, 10, and 11. The internal memory 34 can store information such as text or graphical data, photographs, graphs, scans, charts, and/or x-ray images, to name a few examples. In other embodiments, any number of pages or screens of information in the photo library 36 that can be contained in the internal memory 34 are stored in the data storage and display device 30. Moreover, information for more than one person can be stored in the data transfer software 70, as described below. The software package 42 will run the pages from the photo library 36 and display the pages on the screen 32. In one embodiment, the software package 42 displays the pages from the photo library 36 in a particular order, for example, consecutively on the screen 32. In another embodiment, the software package 42 displays the pages from the photo library 36 on the screen 32 in a random order or an order defined by the user.

Illustrated in FIG. 4, the process displays a person's name, address, and telephone number, from a page in the photo library 36 on the screen 32. The page from the photo library 36 may be configured differently to include other information such as the current date, e-mail address, weight, height, blood type, organ donor instructions, and/or living will instructions, to name a few items.

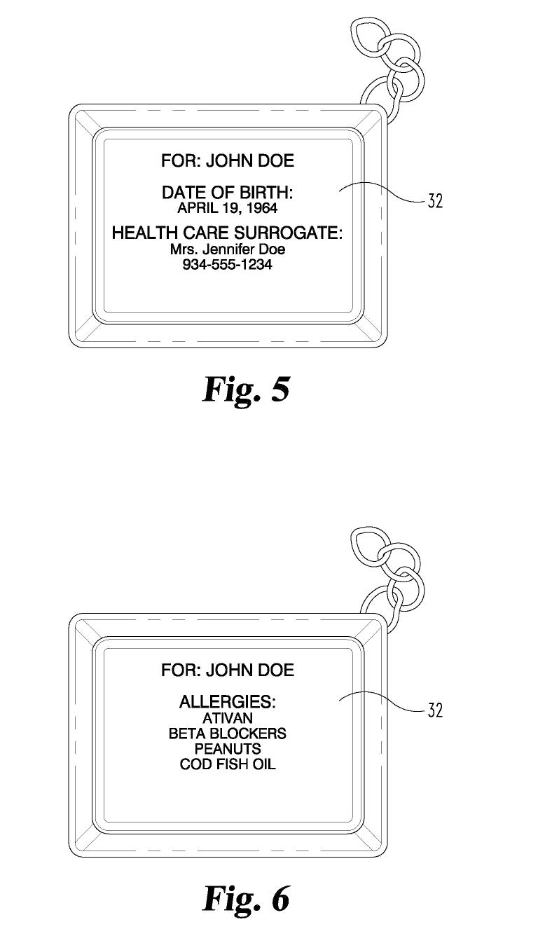

Illustrated in FIG. 5, the process displays the date of birth of the person and a health care surrogate's name and telephone number to contact for an emergency of that person from a page in the photo library 36 on the screen 32. The page from the photo library 36 can be configured differently to include other information such as a place of employment, an e-mail address, and/or additional health care surrogates.

Illustrated in FIG. 6, the process displays the name of the person and allergies of the person from a page in the photo library 36 on the screen 32. If no allergies are known or entered into the internal memory 34, then the page from the photo library 36 would indicate “No Known Allergies” and the screen 32 would display that message. The page from the photo library 36 includes multiple pages listing the allergies of the person.

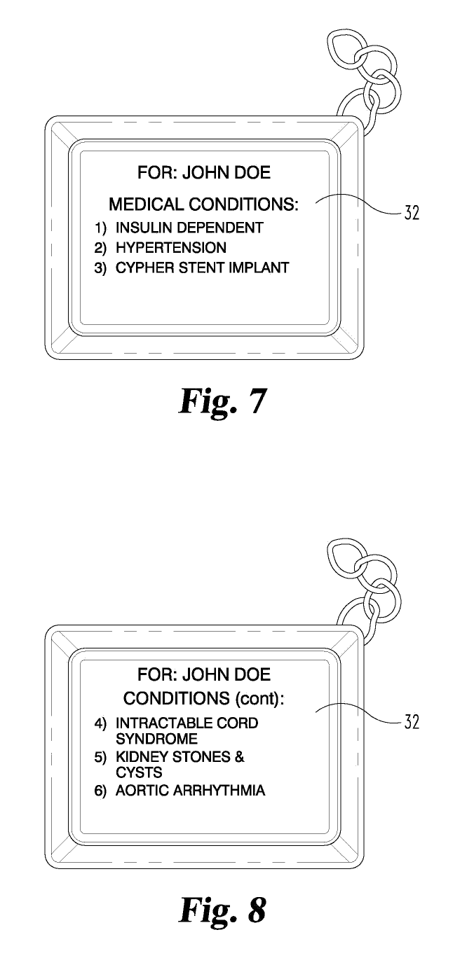

Illustrated in FIGS. 7 and 8, the process displays the name of the person and medical conditions of that person from a page in the photo library 36 on the screen 32. Multiple pages from the photo library 36 list the medical conditions of the person and the process displays multiple pages from the photo library 36, either concurrently or sequentially, on the screen 32.

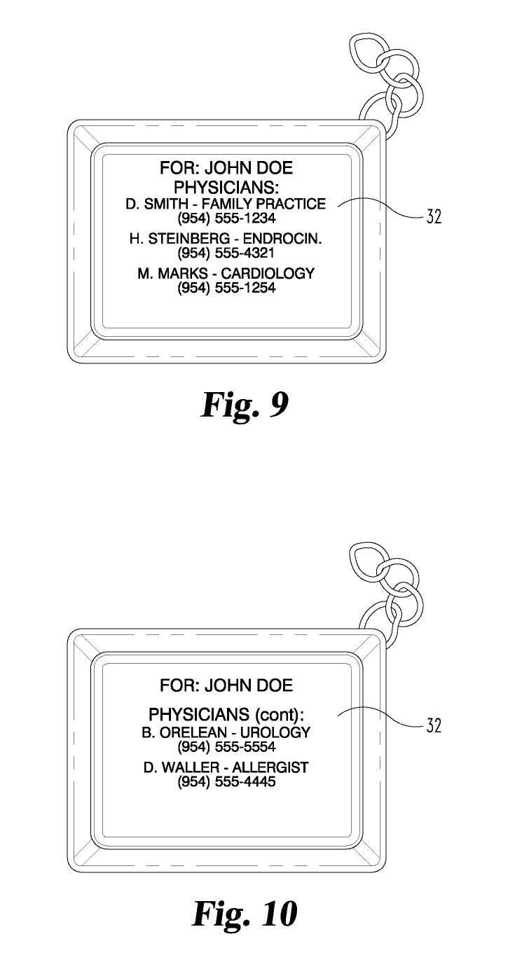

Illustrated in FIGS. 9 and 10, the process displays the name of the person and the physicians or other medical professionals and corresponding telephone numbers that provide care to that person from a page in the photo library 36 on the screen 32. Multiple pages from the photo library 36 can include the physicians and corresponding contact information and the process displays these pages from the photo library 36, either concurrently or sequentially, on the screen 32.

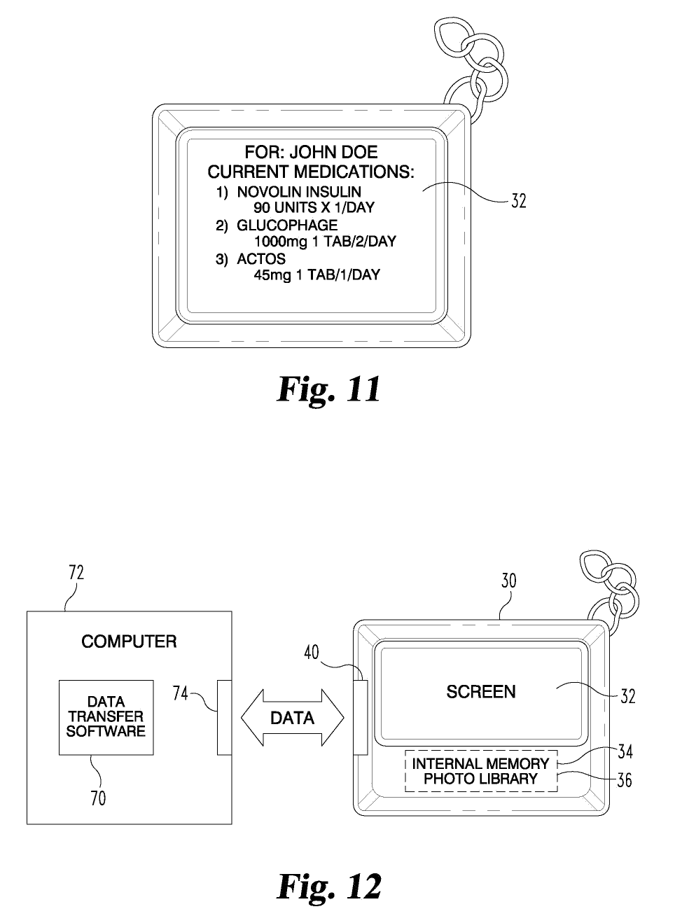

Illustrated in FIG. 11, the process displays the name of the person and medication and corresponding dosages of the medication from a page in the photo library 36 on the screen 32. Multiple pages from the photo library 36 can include the medication, either prescription or non-prescription, vitamins, and supplements, and corresponding dosages, frequency, and strength of the medications, vitamins, and supplements, and the process displays these pages, either concurrently or sequentially, on the screen 32. If no medication, vitamins, or supplements are entered into any pages in the photo library 36, then the process would not display any current medications on the screen 32. In another embodiment, the process would display “None” if no medication, vitamins, or supplements, are entered into the pages in the photo library 36 on the screen 32.

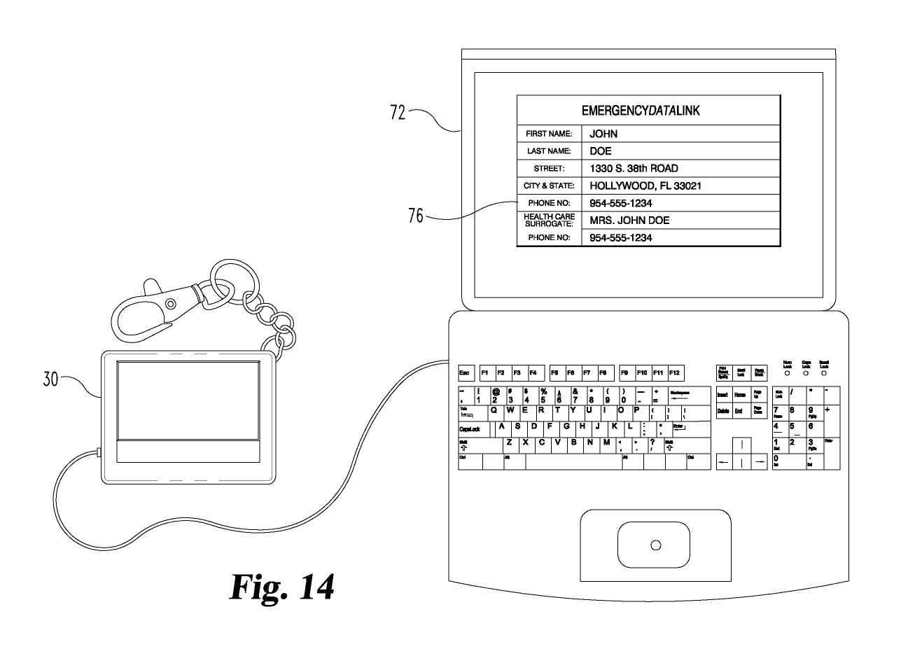

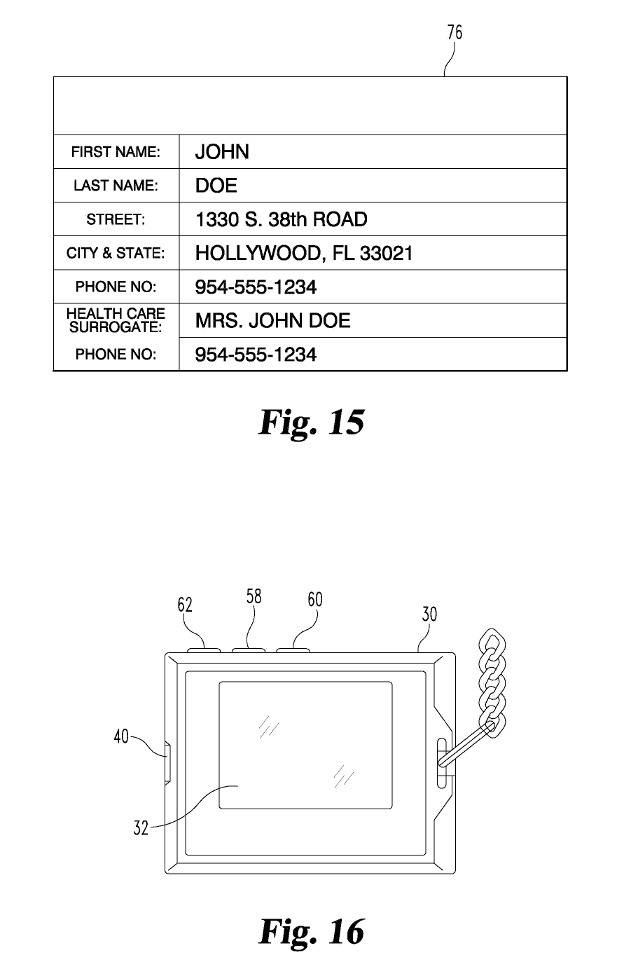

In one process illustrated in FIGS. 12, 14 and 15, personal and/or medical information is entered into a computer 72, arranged in a particular format, and transferred to and stored on the data storage and display device 30. First a user enters the personal and/or medical information into Data Transfer Software 70 developed and sold by JanTel Sales, Inc. that has been loaded onto a personal computer 72 or other device configured to format the information. The Data Transfer Software 70 is derived from computer language software, like DOS, BASIC, HTML, or SQL, to name a few, and the Data Transfer Software 70 is formatted into a “Spreadsheet” with data and image compression and data transfer capabilities on the personal computer 72. In other processes, other types of software may be used to receive and format the personal and/or medical information. The Data Transfer Software 70 prompts the user or operator to enter personal and/or medical information into a plurality of formatted pages of data 76. These formatted pages of data 76 become the pages in the photo library 36 upon transfer of the data via a personal computer interface 74 on the personal computer 72 into the internal memory 34 of the data storage and display device 30 via the personal computer interface 40. As should be appreciated, all of the personal and/or medical information previously discussed with reference to FIGS. 4, 5, 6, 7, 8, 9, 10, and 11, is entered into and formatted by the Data Transfer Software 70 such that the information can be transferred to the data storage and display device 30, stored in pages of information in the photo library 36 in the internal memory 34, and the pages of information from the photo library 36 displayed on the screen 32. Furthermore, any information contained in the photo library 36 and the internal memory 34 can be transferred from the data storage and display device 30 to the personal computer 72 for further use. In another process, the personal and/or medical information is entered through keypad 80 or touch screen keypad 78 on the device 30. In yet another process, information can be entered in the device 30 by touch screen keypad 78, keypad 80, and/or transfer of data via the personal computer interface 74 in the personal computer 72. This information is transferred to the computer 72 and the data transfer software 70 to store for further use, once communication is re-established between the computer 72 and the device 30.

Other forms of collecting, formatting, and transferring personal and/or medical information to the data storage and display device 30 or other types of data storage and display devices may be used. For example, persons may include their information in a questionnaire or e-mail and the information from the questionnaire or e-mail is then entered into a software program that formats the information into pages of the photo library 36. The photo library 36 is then transferred to the data storage and display device 30. As another example, persons may enter their information on a website designed to format the information into pages of the photo library 36, and the pages of the photo library 36 are transferred to the data storage and display device 30. As yet another example, a doctor's office may include software designed to update a user's personal and/or medical information at each visit and format the information into pages of the photo library 36, and transfer the photo library 36 to the data storage and display device 30 at each doctor's visit. Another example includes transferring the photo library 36 from a doctor's office to a cellular telephone, a personal digital assistant, or a palmtop to name a few examples of data storage and display devices.

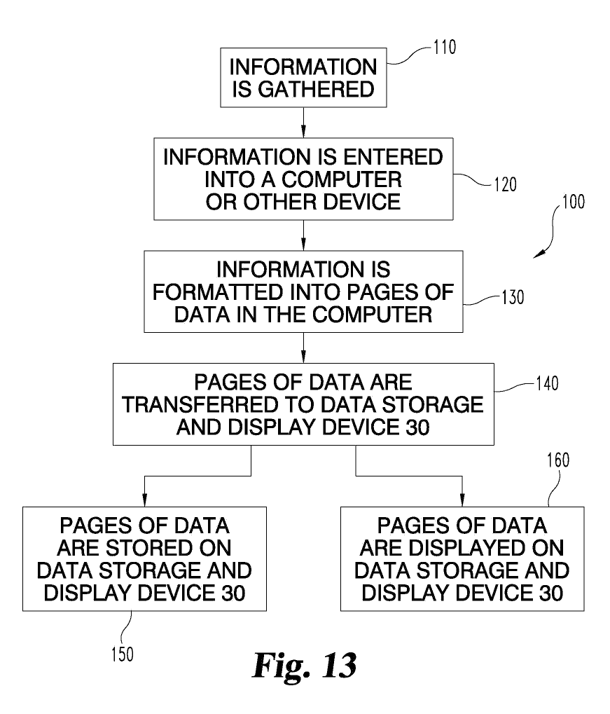

Reference will now be made to FIG. 13 with continued reference to FIGS. 1-12 to illustrate a process flow diagram 100 for the data storage and display device 30. The same reference numerals are used to refer to elements that have already been introduced. Other types of data storage and display devices may be used in the process flow diagram. Flow diagram 100 includes a first step 110 of gathering personal and/or medical information for an individual, of the type of information previously disclosed in the present application. Second step 120 includes entering the information gathered from step 110 into the computer 72, as disclosed previously in the present application. Third step 130 includes formatting the information in the computer 72 into pages of data in a photo library 36. Fourth step 140 includes transferring the pages of data in the photo library 36 to the data storage and display device 30, as disclosed previously in the present application. Fifth step 150 includes storing the pages of data in the photo library 36 in the internal memory 34 of the data storage and display device 30, as disclosed previously in the present application. Sixth step 160 includes displaying the pages of data in the photo library 36 on the screen 32 of the data storage and display device 30, as disclosed previously in the present application. Fifth step 150 and sixth step 160 are performed simultaneously, as disclosed previously in the present application. In some embodiments, pages of data are transferred from the data storage and display device 30 in step 140 to the computer 72 in step 130 to update the personal information. In another embodiment, steps 110, 120, 130, 140, and 150 can be performed for additional users. In this embodiment, step 160 displays only pages of data for one individual at a time. In other words, step 160 displays all the pages of data for each individual before displaying pages of data for the next individual stored in the data storage and display device 30.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for providing information related to an individual in a data display and storage device, the method comprising:
entering the information of into a plurality of electronic formatted screens on a computer;
transferring the electronic formatted screens to the data display and storage device;
storing the electronic formatted screens in the data display and storage device; and
displaying in a sequential order only those electronic formatted screens that contain the information.

2. The method of claim 1, further comprising:
transmitting the electronic formatted screens from the data display and storage device to a receiving facility configured to receive the electronic formatted screens.

3. The method of claim 1, wherein the electronic formatted screens include a name, an address, a telephone number, a date of birth, a name of a health care surrogate, a telephone number of the health care surrogate, one or more allergies, one or more medical conditions, one or more physicians, and one or more medications.

4. The method of claim 1, wherein the data display and storage device is portable.

5. The method of claim 1, further comprising:
collecting said information of said individual from a questionnaire, an e-mail, a medical record, or a website.

6. A method for use in a portable display and storage device, the method comprising:
entering medical and personal information of an individual in formatted screens of data in a computer;
transferring the formatted screens of data to the portable display and storage device;
storing the formatted screens of data in the portable display and storage device; and
displaying the formatted screens of data in the portable display and storage device.

7. The method of claim 6, wherein the displaying the formatted screens of data include a name, an address, and a telephone number on a first screen of data.

8. The method of claim 7, wherein the displaying the formatted screens of data include said name, a date of birth, and a name and a telephone number of a health care surrogate on a second screen of data.

9. The method of claim 8, wherein the displaying the formatted screens of data include said name and one or more allergies on a third screen of data.

10. The method of claim 9, wherein the displaying the formatted screens of data include said name and one or more medical conditions on a fourth screen of data.

11. The method of claim 10, wherein the displaying the formatted screens of data include said name and one or more physicians on a fifth screen of data.

12. The method of claim 11, wherein the displaying the formatted screens of data include said name and one or more medications on a sixth screen of data.

13. A method for use in a portable electronic display and storage device, the method comprising:
displaying medical and personal information of an individual in said portable electronic display and storage device, said medical and personal information formatted in standardized screens of data.

14. The method of claim 13, wherein the displaying the medical and personal information of an individual in said portable electronic display and storage device include a name, an address, and a telephone number on a first screen of data.

15. The method of claim 14, wherein the displaying the medical and personal information of an individual in said portable electronic display and storage device include said name, a date of birth, and a name and a telephone number of a health care surrogate on a second screen of data.

16. The method of claim 15, wherein the displaying the medical and personal information of an individual in said portable electronic display and storage device include said name and one or more allergies on a third screen of data.

17. The method of claim 16, wherein the displaying the medical and personal information of an individual in said portable electronic display and storage device include said name and one or more medical conditions on a fourth screen of data.

18. The method of claim 17, wherein the displaying the medical and personal information of an individual in said portable electronic display and storage device include said name and one or more physicians on a fifth screen of data.

19. The method of claim 18, wherein the displaying the medical and personal information of an individual in said portable electronic display and storage device include said name and one or more medications on a sixth screen of data.

20. The method of claim 13, further comprising:
viewing the medical and personal information formatted in standardized screens of data on the display and storage device without additional equipment required to access the standardized screens of data.
